(19) United States
(12) Patent Application Publication
(10) Pub. No.: US 2026/0070258 A1
(43) Pub. Date: Mar. 12, 2026

(54) MOLD PART FOR MANUFACTURING TOOTHED VERTICAL JOINTS OF KEYSTONES AND MOLD COMPRISING THE MOLD PART

(71) Applicant: NORDEX ENERGY SPAIN, S.A.U., Navarra (ES)

(72) Inventors: Vanessa CERRILLO GÓMEZ, Navarra (ES); David CAMARERO TABLADO, Navarra (ES)

(21) Appl. No.: 18/723,107

(22) PCT Filed: Dec. 1, 2022
(86) PCT No.: PCT/EP2022/084040

§ 371 Date: Jun. 21, 2024

(30) Foreign Application Priority Data
Dec. 23, 2021 (EP) 21383212.4

(51) Int. Cl. B28B 7/00; B28B 1/14; B28B 7/06; B28B 13/06; E04C 1/39

(52) U.S. Cl. CPC B28B 7/0079; B28B 1/14; B28B 7/06; B28B 13/062; E04C 1/39

(57) ABSTRACT

A mold part (6) for manufacturing vertical joints of keystones (5) comprising a foam piece (7); and a silicone piece (11) covering the foam piece (11), wherein the foam piece (7) and the silicone piece comprise a plurality of protrusions (17) and recesses (16), thus providing a toothed surface in a concrete surface of the vertical joint. The mold-part can comprise stiffeners (20) and handles (19, 21) for demolding manually after curing the concrete keystones, leaving the inner surface of the keystone with a toothed appearance.

### OBJECT OF THE INVENTION

The invention is referred to the field of manufacturing of keystones for concrete towers of windturbines, more specifically, the invention relates to a mold part for manufacturing vertical joints of keystones having a specific toothed surface.

The invention also relates to a mold comprising the mold part for manufacturing vertical joints having a toothed surface.

### BACKGROUND ART

A solution from the state of the art is a method for denticulation of a concrete cast joint between a first and a second cast section characterized by that a studded plate is used for the formwork close of the first cast section and that the studded plate is subsequently removed before the second section is cast. This document discloses the use of said studded plate in manufacturing of cast joints between large concrete components such as in bridges, tunnels and in the walls of buildings, dams or containers, and more particularly in boxed walls on a free balanced cantilever.

Another solution disclosed in the state of the art is a method which involves embossing a block or slab surface with a recess or projections. The recess is a groove with parallel, slant, plane or a curved wall and a floor, where the projection is toothed. In this process, the surfaces are embossed and the concrete blocks or concrete slabs are demolded before solidification and cure externally.

The surfaces are further processed in a subsequent operation, wherein tooth strips extending over the entire surface of the concrete blocks or concrete slabs are flattened by means of a milling process.

Another solution to achieve roughness in the vertical joint of the keystones requires foam and nervometal or metal grid.

The aforementioned solutions do not provide a solution for manufacturing vertical joints of keystones having a pattern to provide roughness in the concrete piece in an effective way.

### DESCRIPTION OF THE INVENTION

The present invention discloses a mold part for manufacturing a vertical joint of keystones. The aim of this mold part is to provide a toothed surface in a concrete surface of the vertical joint of the keystones, which increases the friction surface between adjacent keystones once the concrete has been poured into the vertical joint thus, restricting the vertical relative movement between them, and additionally allows the mold part to be demolded by hand, without machines.

The mold part of the invention is intended to be disposed on a framework of the keystone, and comprises a first piece and a second piece, which covers at least partially the first piece. The second piece comprises an inner surface and an outer surface so that at least said outer surface comprises a plurality of protrusions and recesses to define a toothed surface in the concrete surface of the vertical joint of the keystone. The protrusions and recesses have, preferably, at least 5 mm in depth and could have different shapes. These different shapes thus defining a sequence of circular or polygonal shapes, such as triangular or rectangular shapes. More preferably, the protrusions and recesses could be sloped or tilted.

The first piece and the second piece of the mold part are made of flexible materials having enough stiffness to support the pressure exerted by the concrete. Preferably, the first piece could be made of foam or a low-density flexible polymer and the second piece could be made of elastomeric resin, and more preferably silicone elastomer.

The first piece and the second piece could have a plurality of shapes, such as an U-shape or a trapezoidal shape.

In a first embodiment, the mold part for manufacturing the toothed vertical joint of the keystone comprises a first piece, comprising the plurality of protrusions and recesses, and a second piece being a coating layer covering at least partially the first piece, such that said coating layer also comprises the plurality of protrusions and recesses in both its inner surface and outer surface.

Preferably, the first piece is a foam or low density flexible polymer piece and the second piece is a silicone layer of at least 5 mm of thickness.

In a second embodiment of the invention, the second piece of the mold part is a cover comprising two lateral surfaces, a base surface and a gap between the lateral surfaces opposed to the base surface. The second piece could also comprise at least one sloped surface in at least one of the two lateral surfaces.

In this embodiment, the first piece is a solid piece comprising two lateral surfaces, a base surface and a top surface.

Preferably, the first piece is a foam or low density flexible polymer piece and the second piece is a silicone cover of at least 5 mm of thickness.

The silicone cover comprise handles for making easier the demolding process. The handles could be fabric strips, plastic or metallic handles.

In a third embodiment of the invention, the second piece of the mold part is also a silicon cover comprising two lateral surfaces, a base surface and a gap between the lateral surfaces opposed to the base surface, as explained in the second embodiment.

Nevertheless, the first piece of the mold part comprises two lateral surfaces, a base surface, a top surface, and an opening in the top surface.

Preferably, the first piece is a foam or low density flexible polymer piece and the second piece is a silicone cover of at least 5 mm of thickness.

The second piece could also comprise at least one sloped surface in at least one of the two lateral surfaces.

In this embodiment, the mold part further comprises at least one longitudinal stiffener, such that the opening of the first piece is configured to receive said stiffener.

The stiffener could be made of wood or metal and pushes the first piece towards the second piece, also called cover.

Both the stiffener and the silicone cover comprise handles for making easier the demolding process. The handles could be fabric strips, plastic or metallic handles.

Preferably, the mold part of the invention comprises a plurality of first pieces and second pieces connected one to another longitudinally along the whole vertical joint of the keystone. For that, each of the second pieces can comprise a tongue-and-groove joint for connecting a second piece longitudinally with another second piece.

In case that, the stiffeners are included, as in the third embodiment, a plurality of said stiffeners are connected one to another longitudinally along the whole vertical joint of the keystone.

In this case, the connection section of the stiffeners is not coincident with a connection section of the silicone covers for avoiding the inputting of concrete in the mold part.

The invention is also referred to the whole mold for manufacturing keystones which comprises the mold part described, along with, a base and a counter mold. In use, said base is intended to support a framework of the keystone, the counter mold is intended to be pushed towards the base and to the framework, and the mold part is placed on the framework of the keystone.

The mold part of the invention allows to remove it manually after demolding the keystone, leaving the inner surface of the keystone with a toothed appearance.

Preferably, the dents on the surfaces of the mold are 5 mm of depth and these give to the inner surfaces of the vertical joint the same roughness than using nervometal.

On using the mold part of the invention, a reduction in material consumption and costs achieved, since the mold part is reusable while the state-of-the-art embedded nervometal solution is consumable.

The invention also refers to a manufacturing process of keystones comprising a toothed surface in a vertical joint comprising the steps of:
placing the mold part described on a framework;
placing the framework with the mold part on the base of the mold for manufacturing keystones;
closing the mold for manufacturing keystones pushing a counter mold towards the base and towards the framework with the mold part;
pouring concrete on the mold;
demolding the keystone by opening the mold and removing the counter mold from the base and from the framework with the mold part; and
removing the mold part from the keystone, defining a toothed surface in a concrete surface of a vertical joint of the keystone.

Alternatively, the mold part could be placed in the framework after being placed said framework on the base of the mold. Also, the step of removing the mold part from the keystone could be done in-situ or after being carried the keystone to another zone.

When the mold part comprises the stiffener, the step of removing the mold part, comprises the stages of removing the stiffener by pulling its handles and removing the silicone piece, and also the foam piece, by pulling its handles.

### DESCRIPTION OF THE DRAWINGS

FIG. 1. shows an example of a state of the art solution for manufacturing a vertical joint keystones comprising a foam piece, and a metallic grid.

FIG. 2. shows the whole mold for producing keystones with a vertical joint in an opened position (2A) and in the closed position (2B).

FIG. 3. shows the resulting keystone manufactured by using the mold part of the invention comprising a toothed surface.

FIG. 4 shows a first preferred embodiment of the mold part of the invention showing a front view of the mold part (4A) and a lateral view of the mold part (4B) showing the protrusions and recesses.

FIG. 5. shows a second preferred embodiment of the mold part of the invention, showing a front view of the second piece (5A) and a lateral view of said second piece (5B), showing the protrusions and recesses, a front view of the first piece (5C), and a lateral view of said first piece (5D). Also, is shown a front view of the section AA of FIG. 5B of the mold part with all pieces already mounted, comprising the first piece and the second piece (5E). FIG. 5F shows the vertical joint of the keystone with the mold part, the first piece and the second piece, already placed.

FIG. 6 shows a third preferred embodiment of the mold part of the invention, showing a front view of the second piece (6A), a lateral view of said second piece (6B) showing the protrusions and recesses, a front view of the first piece (6C) comprising a gap for housing a stiffener, a lateral view of said first piece (6D), a lateral view of the stiffener (6E) and a front view of the stiffener (6F). Also, a front view of the section AA of FIG. 6B of the mold part with all pieces already mounted, comprising the first piece, the second piece covering the first piece and the first piece housing the stiffener. A lateral exploded view of a mold part (6H) comprising a plurality of second pieces, first pieces and stiffeners connected one to another longitudinally is shown.

FIG. 7 shows perspective views of the second piece of the second and third preferred embodiments of the mold part of the invention, both in a closed position (7A) and in an open position (7B).

### PREFERRED EMBODIMENTS OF THE INVENTION

As it has been explained before, the mold part is configured to define a toothed surface in a concrete surface of the vertical joint of the keystone (22).

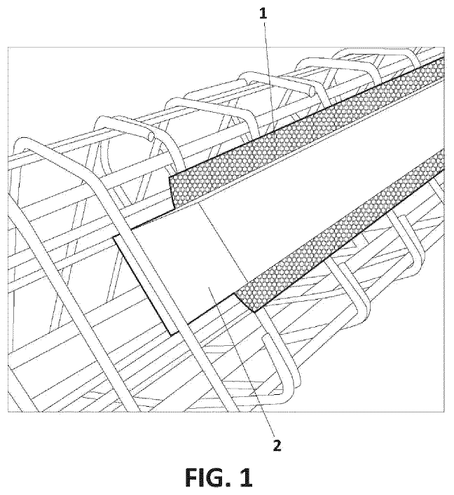

FIG. 1 shows an example of state of the art solutions for manufacturing a vertical joint of keystones (22). The state-of-the-art mold comprises a foam piece (2), and a metallic grid (1). In use, the grid (1) is placed in contact with the concrete, for stamping a pattern in the concrete. Then, the foam piece (2) is placed on the grid (1) for completing the mold.

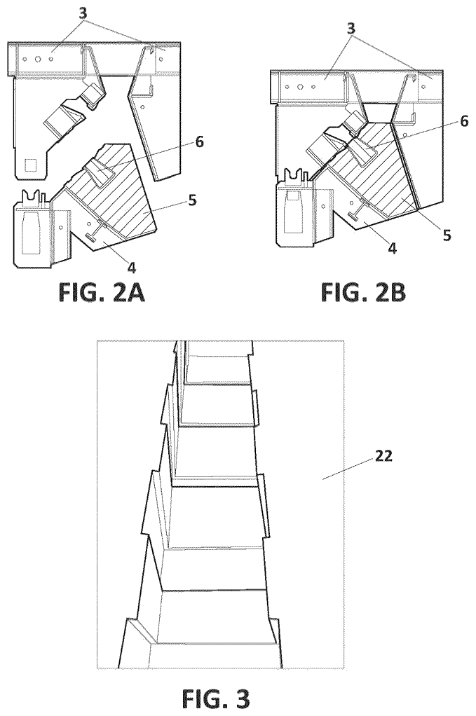

FIGS. 2A and 2B represent the whole mold for producing keystones (22) comprising a base (4), a counter mold (3), a framework (5) and a mold part (6) for manufacturing a toothed vertical joint. FIG. 2A shows the mold opened, with the counter mold (3) separated from the base (4), and the FIG. 2B shows the mold closed, with the counter mold (3) pushed towards the base (4). In use, the base (4) is intended to support the framework (5) of the keystone (22) and the counter mold (3) is intended to be pushed towards the base (4) and to the framework (5). Then, the mold part (6) is placed on the framework (5) of the keystone (22).

In use, the mold part (6) is placed into the framework (5) of the keystone (22), before pouring the concrete, to manufacture the vertical joint of the keystone (22). Once the mold part (6) is perfectly placed, the concrete is poured and when the concrete is cured, the mold part (6) will be removed. The mold part (6) of the invention allows to be demolded by hand, without machines. Therefore, the mold part (6), in use, is in contact with the concrete surface of the vertical joint of the keystone (22).

FIG. 3 shows the resulting keystone (22) manufactured by using the mold and the mold part of FIGS. 2A and 2B. More particularly, FIG. 3 shows the toothed surface generated by the mold part (6) of the invention in the concrete keystone (22).

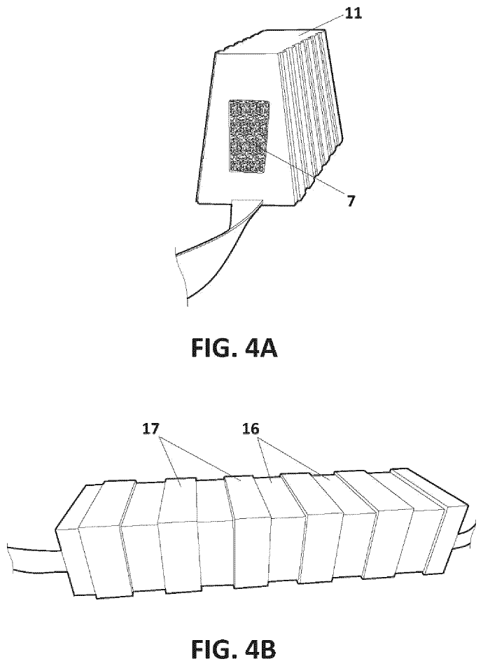

The invention relates to the mold part (6) for manufacturing the toothed vertical joint of the keystones. FIGS. 4A and 4B show a first preferred embodiment of the mold part (6) of the invention which comprises a first piece (7). In this case, the first piece (7) comprises a trapezoidal shape. The first piece (7) comprises two lateral surfaces (9) and a base surface (8), and a plurality of protrusions (17) and recesses (16). The protrusions (17) and recesses (16), in this case, are rectangular strips extending along the two lateral surfaces (9) and the base surface (8). Also, the mold part (6) comprises a second piece (11), which in this case is a silicone layer (11) of at least 5 mm of thickness covering the first piece (7). Particularly, FIG. 4A shows a front view of the mold part (6) and FIG. 4B shows a lateral view of said mold part (6).

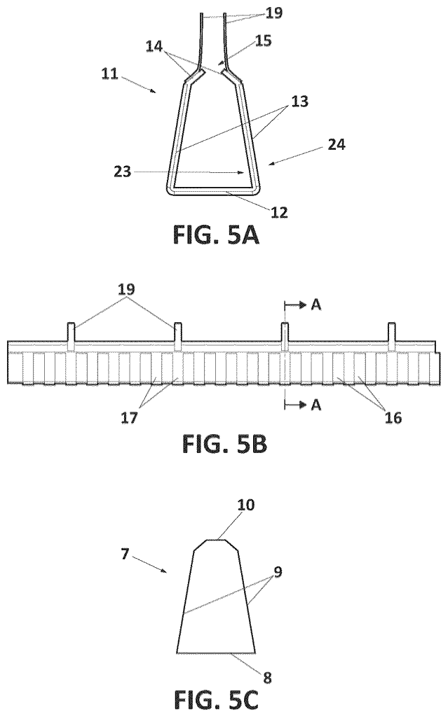

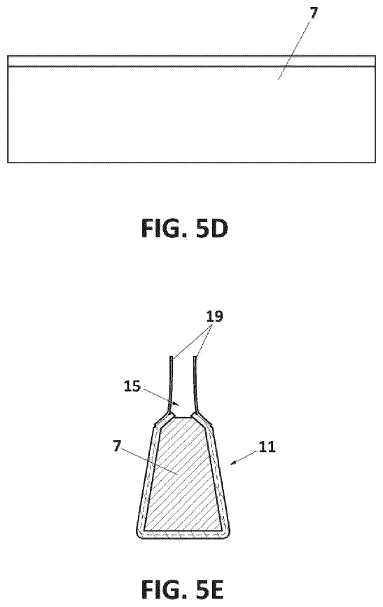

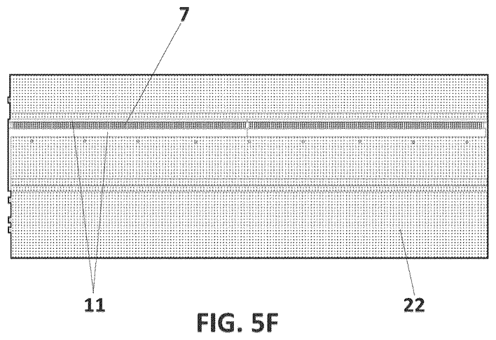

FIGS. 5A, 5B, 5C, 5D, 5E and 5F show a second preferred embodiment of the mold part (6) of the invention. FIG. 5A shows the second piece (11) which is a silicone cover for covering the first piece (7). The second piece (11) comprises a gap (15) for introducing the first piece (7). Thus, the second piece (11) comprises an inner surface (23) and an outer surface (24), wherein preferably the inner surface (23) is a flat surface and the outer surface (24) comprises a plurality of protrusions (17) and recesses (16) configured to define a toothed surface in a concrete surface of the vertical joint of the keystone (22). In this particular case, the second piece (11) comprises a base surface (12), two lateral surfaces (13) and two sloped surfaces (14) opposed to the base surface (12) and leaving a gap (15) between them for introducing the first piece (7). Also, the second piece comprises handles (19) attached to the sloped surfaces (14).

In this case the second piece (11) comprises a trapezoidal shape.

FIG. 5B shows a lateral view of the second piece (11), comprising a plurality of rectangular protrusions (17) and recesses (16), extending along the outer surface (24) of the second piece (11), and the handles (19). Also, a section AA is marked in FIG. 5B.

FIG. 5C shows the first piece (7). In this case, the first piece (7) is a solid foam piece (7) having a trapezoidal shape, with a flat base surface (8), two lateral flat surfaces (9) and a rounded top surface (10). FIG. 5D shows a lateral view of said first piece (7).

FIG. 5E shows a front view of the section AA marked in the FIG. 5B, showing the mold part (6) mounted, which comprises the first piece (7) housed by the second piece (11). Also, the handles (19) of the second piece are shown, along with the protrusions (17) and recesses (16), which are represented in dashed lines.

FIG. 5F shows a lateral view of the keystone (22) having the mold part (6) mounted placed in the vertical joint. The mold part (6) comprises the first piece (7) placed inside the second piece (11).

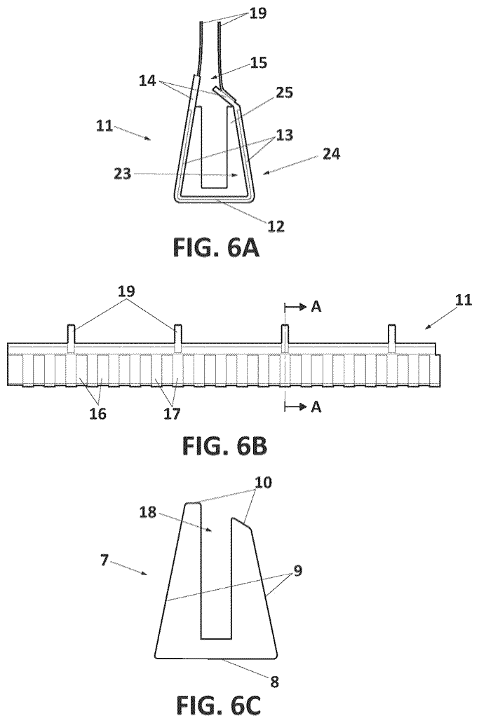

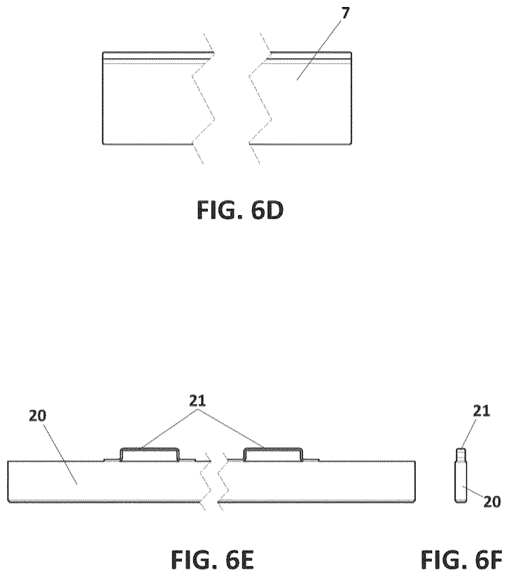

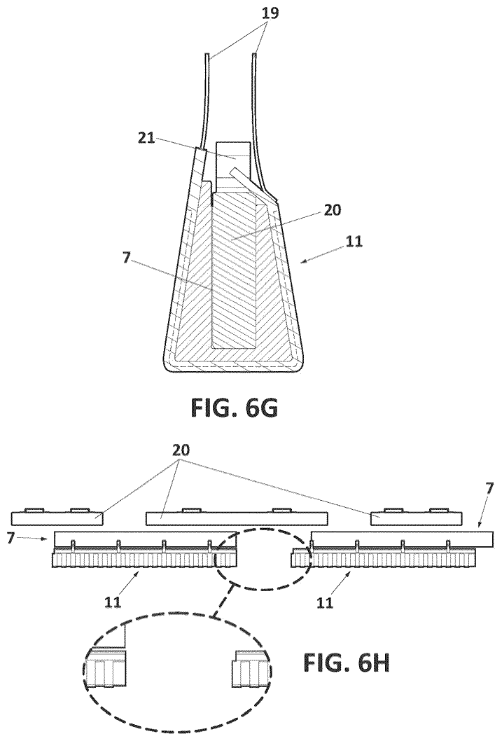

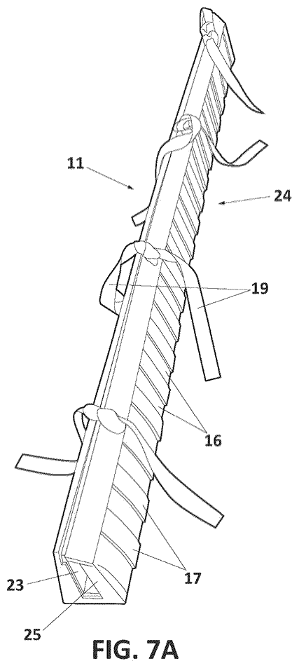

FIGS. 6A, 6B, 6C, 6D, 6E, 6F, 6G and 6H show a third preferred embodiment of the mold part (6) of the invention.

FIG. 6A shows the second piece (11), which in this case is a trapezoidal silicone cover comprising an inner surface (23), an outer surface (24) and a gap (15) for housing the first piece (7). The second piece (11) also comprises two lateral surfaces (13), and two sloped surfaces (14), adjacent to the lateral surfaces (13), for sealing the gap (15) avoiding the input of concrete in the gap (15) when the concrete is poured on the mold. In this particular case, just one of the sloped surfaces (14) is more inclined towards the gap (15) for better sealing it. The second piece (11) also comprises handles (19) for demolding attached to the sloped surfaces (14). The second piece (11) also comprises two edges comprising each edge a fin (25) for securing the first piece (7) inside the second piece (11).

FIG. 6B shows a lateral view of the second piece (11) comprising the protrusions (17) and recesses (16). FIG. 6B also shows the handles (19) of the second piece (11).

FIGS. 6C and 6D show a front and a lateral view of the first piece (7), which in this case is a trapezoidal foam piece, comprising a top surface (10) and an opening (18) in said top surface (10) for housing at least one stiffener (20).

FIGS. 6E and 6F show a lateral view and a front view of the stiffener (20) for being placed in the first piece (7). The stiffener comprises handles (21) for demolding, extracting the stiffener (20) from the first piece (7). Preferably, the handles (19, 21) could be fabric strips, plastic or metallic handles.

The stiffener (20) could comprise a core made of steel, and a cover made of rubber.

FIG. 6G shows a front view of the section AA of FIG. 6B of the third preferred embodiment of the mold part (6) of the invention assembled. The mold part (6) comprising the second piece (11) covering the first piece (7), and the stiffener (20) placed on the first piece (7).

FIG. 6H shows a lateral view of a plurality of second pieces (11), comprising the toothed surface, connected one to another in a longitudinal way, by means of a tongue-and-groove joint, as shown in the detail of FIG. 6H. FIG. 6H also shows the stiffeners (20) for being placed on the first pieces (7), which, in turn, are to be placed over the second pieces (11).

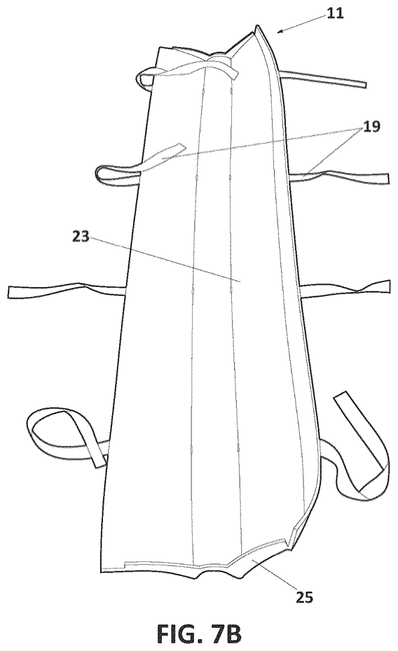

FIG. 7A shows a perspective view of the second piece (11) of the second and third preferred embodiments of the mold part (6) of the invention in a closed position and comprising the handles (19) for demolding and the toothed surface. FIG. 7B shows the second piece in an open position, ready to introduce the first piece (7) inside. FIGS. 7A and 7B show the second piece (11) comprising the inner surface (23) and the outer surface (24) and, also, comprising the fins (25) placed in both edges of the second piece (11).

1. A mold part (6) for manufacturing vertical joints of keystones (22), which is intended to be disposed on a framework (5) of the keystone (22), comprising:
a first piece (7); and
a second piece (11) covering at least partially the first piece (7), the second piece (11) comprising an inner surface (23) and an outer surface (24),
wherein at least the outer surface (24) of the second piece (11) comprises a plurality of protrusions (17) and recesses (16) configured to define a toothed surface in a concrete surface of the vertical joint of the keystone (22).

2. The mold part (6) according to claim 1, wherein the first piece is a foam piece.

3. The mold part (6) according to anyone of the previous claims, wherein the second piece is a silicone piece.

4. The mold part (6) according to anyone of the previous claims, wherein the first piece (7) comprises the protrusions (17) and recesses (16) and the second piece (11) is a coating layer covering at least partially the first piece (7).

5. The mold part (6) according to any of claims 1 to 3, wherein the second piece (11) is a cover comprising two lateral surfaces (13) and a base surface (12), wherein the second piece (11) comprises a gap (15) between the lateral surfaces (13) opposed to the base surface (12).

6. The mold part (6) according to claim 5, wherein the first piece comprises two lateral surfaces (9), a base surface (8) and a top surface (10), the first piece being a solid piece.

7. The mold part (6) according to claim 5, wherein the first piece comprises two lateral surfaces (9), a base surface (8), a top surface (10), and an opening (18) in the top surface (10), the mold part (6) further comprising at least one longitudinal stiffener (20) configured to be placed in the opening (18) of the first piece (7), pushing it towards the second piece (11).

8. The mold part (6) according to any of previous claims, comprising a plurality of first pieces (7) and second pieces (11) connected one to another longitudinally, thus, defining a connection section.

9. The mold part (6) according to claim 8, wherein the second pieces comprise tongue-and-groove joints in the connection section of the second pieces (11).

10. The mold part (6) according to any of claims 8 to 9, comprising a plurality of stiffeners (20) connected one to another longitudinally such that the connection section is not coincident with the connection section of the second pieces (11).

11. The mold part (6) according to any of claims 1 to 10, wherein the plurality of protrusions (17) and recesses (16) define a sequence of polygonal or circular shapes.

12. A mold for manufacturing keystones (5) comprising a base (4), a counter mold (3) and the mold part (6) of any of the previous claims, wherein, in use, the base (4) is intended to support a framework (5) of the keystone (22), and the counter mold (3) is intended to be pushed towards the base (4) and to the framework (5), the mold part (6) being placed on the framework (5) of the keystone (22).

13. A manufacturing process of keystones (5) comprising a toothed surface in a vertical joint comprising the steps of:
placing the mold part (6) according to any of claims 1 to 11 on a framework (5);
placing the framework (5) with the mold part (6) on a base (4) of a mold for manufacturing keystones (5);
closing the mold for manufacturing keystones (5) pushing a counter mold (3) towards the base (4) and towards the framework (5) with the mold part (6);
pouring concrete on the mold;
demolding the keystone (22) by opening the mold and removing the counter mold (3) from the base (4) and from the framework (5) with the mold part (6); and
removing the mold part (6) from the keystone (22), defining a toothed surface in a concrete surface of a vertical joint of the keystone (22).

14. The manufacturing process according to claim 13, wherein the step of removing the mold part (6) from the keystone (22), comprises the stages of removing a stiffener (20) by pulling its handles (21) and removing the second piece (11), which houses the first piece (7), by pulling its handles (19).
